(19) United States
(12) Patent Application Publication
(10) Pub. No.: US 2025/0178355 A1
(43) Pub. Date: Jun. 5, 2025

(54) LIQUID DISCHARGE HEAD AND LIQUID DISCHARGE APPARATUS

(71) Applicant: Jun ICHINOWATARI, Kanagawa (JP)

(72) Inventor: Jun ICHINOWATARI, Kanagawa (JP)

(21) Appl. No.: 18/945,642

(22) Filed: Nov. 13, 2024

(30) Foreign Application Priority Data
Nov. 30, 2023 (JP) 2023-202859

(51) Int. Cl. B41J 2/175; B41J 2/14

(52) U.S. Cl. CPC B41J 2/17596; B41J 2/1433

(57) ABSTRACT

A liquid discharge head includes a nozzle plate, a valve, an actuator, and an arm. The nozzle plate has a nozzle to discharge a liquid. The valve is movable in a first direction to open and close the nozzle. The valve includes a contacted portion in a part of the valve. The actuator is displaceable to move the valve relative to the nozzle. The arm is swingable by a displacement of the actuator to move the valve in the first direction between an open position and a closed position. The arm extends in a second direction. The arm has a connection portion, a contact portion, and an arm side face. The connection portion is connected to the actuator. The contact portion contacts the contacted portion of the valve in the first direction. The arm side face faces an outer circumferential face of the valve with a clearance.

### CROSS-REFERENCE TO RELATED APPLICATION

This patent application is based on and claims priority pursuant to 35 U.S.C. § 119(a) to Japanese Patent Application No. 2023-202859, filed on Nov. 30, 2023, in the Japan Patent Office, the entire disclosure of which is hereby incorporated by reference herein.

### BACKGROUND

### Technical Field

The present disclosure relates to a liquid discharge head and a liquid discharge apparatus.

### Related Art

In the related art, a liquid discharge head includes a nozzle to discharge a liquid, a valve to open and close the nozzle, and a moving mechanism to move the valve between an open position at which the nozzle is opened and a closed position at which the nozzle is closed.

### SUMMARY

The present disclosure described herein provides an improved liquid discharge head including a nozzle plate, a valve, an actuator, and an arm. The nozzle plate has a nozzle to discharge a liquid. The valve extends in a first direction and is movable in the first direction to open and close the nozzle. The valve includes a contacted portion in a part of the valve. The actuator is displaceable to move the valve relative to the nozzle. The arm is swingable by a displacement of the actuator to move the valve in the first direction between an open position at which the valve opens the nozzle and a closed position at which the valve closes the nozzle. The arm extends in a second direction intersecting the first direction. The arm has a connection portion, a contact portion, and an arm side face. The connection portion is connected to the actuator. The connection portion is disposed at one end of the arm in the second direction. The contact portion contacts the contacted portion of the valve in the first direction. The contact portion is disposed at another end of the arm opposite the one end in the second direction. The arm side face faces an outer circumferential face of the valve with a clearance.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external perspective view of a liquid discharge head;

FIGS. 2A and 2B are diagrams each illustrating the arrangement of nozzles of a nozzle plate;

FIGS. 3A and 3B are diagrams illustrating the mechanical fixation of a nozzle plate and a channel substrate;

FIG. 4 is a cross-sectional view taken along line A-A in FIG. 1;

FIG. 5 is a partial detailed view of a liquid discharge module;

FIG. 6 is an enlarged view of a portion surrounded by broken line J in FIG. 5;

FIG. 7 is a schematic diagram illustrating a part of a cross section taken along line B-B in FIG. 4;

FIG. 8 is a schematic diagram illustrating a part of a cross section taken along line C-C in FIG. 4;

FIG. 9 is a perspective view of a liquid discharge module;

FIG. 10 is a perspective view of a liquid discharge module including an actuator provided with a holder according to a modification;

FIGS. 11A and 11B are schematic views of an arm;

FIGS. 12A and 12B are diagrams illustrating a configuration of a part of an arm according to a comparative example;

FIGS. 13A to 13C are diagrams illustrating a configuration of a part of an arm having a flat contact portion according to a comparative example;

FIGS. 14A and 14B are schematic diagrams illustrating a contact portion of an arm and the surroundings thereof,

FIG. 15 is a diagram illustrating a displacement distribution of an arm in the Z direction when an actuator is driven;

FIGS. 16A and 16B are schematic views of an arm according to a modification;

FIGS. 17A and 17B are schematic views of a part of a liquid discharge head according to a modification;

FIG. 18 is an enlarged view of a portion indicated by broken line G in FIG. 17B;

FIG. 19 is a schematic perspective view of a liquid discharge apparatus;

FIG. 20 is a diagram illustrating a supply device that supplies paint to multiple liquid discharge heads; and

FIG. 21 is a diagram illustrating an electrode manufacturing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. It is to be understood that those skilled in the art can easily modify and change the present disclosure within the scope of the appended claims to form other embodiments, and these modifications and changes are included in the scope of the appended claims. The following embodiments are illustrative and do not limit the scope of the appended claims.

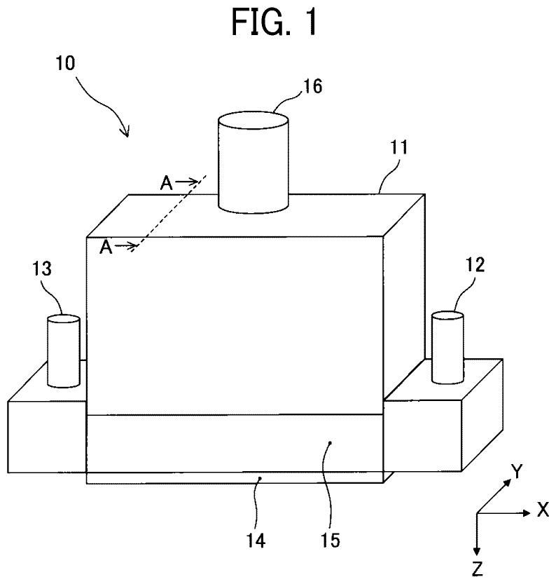

FIG. 1 is an external perspective view of a liquid discharge head 10.

In the following description, a nozzle array direction (longitudinal direction of the liquid discharge head 10) is an X direction, a liquid discharge direction from nozzles (height direction of the liquid discharge head 10) is a Z direction, and a direction (transverse direction of the liquid discharge head 10) orthogonal to both the X direction and the Z direction is a Y direction.

The liquid discharge head 10 includes a nozzle plate 14, a channel substrate 15, and a cover 11 as a housing. The channel substrate 15 is provided with a supply port 12, through which liquid is supplied, at one end of the channel substrate 15 in the X direction, and a drain port 13, through which the liquid is drained, at the other end of the channel substrate 15 in the X direction. The cover 11 is provided with a harness hole 16, through which a harness for communicating with an actuator 2 accommodated in the cover 11 is inserted, in an upper portion of the cover 11.

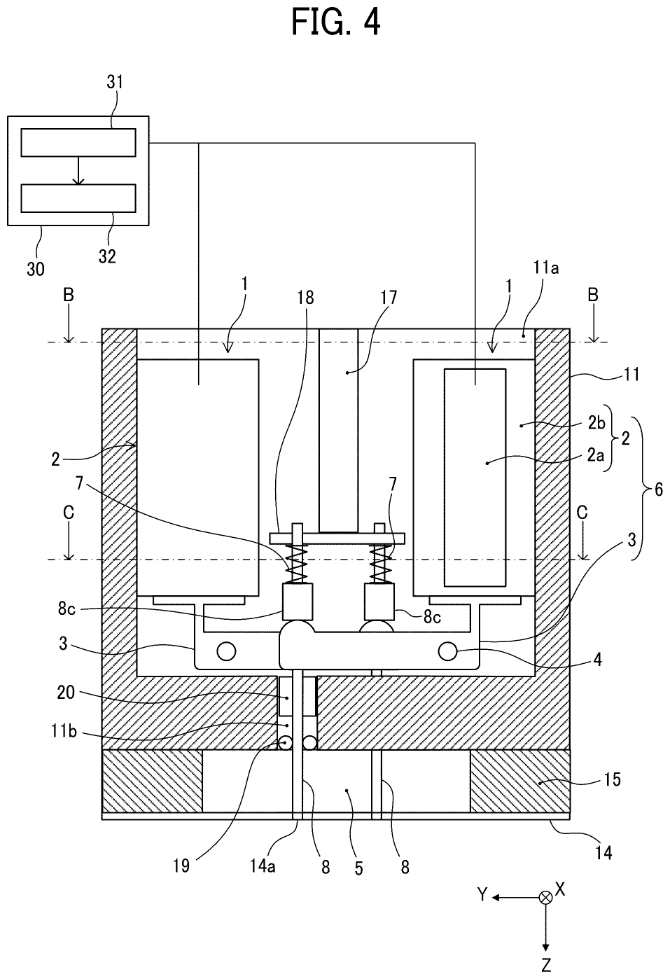

The nozzle plate 14, the channel substrate 15, and the cover 11 are made of metal, resin, or ceramics. The cover 11 accommodates and supports liquid discharge modules 1 described below (see FIG. 4). The channel substrate 15 defines channels through which liquid flows, and the nozzle plate 14 has multiple nozzles to discharge a liquid. The nozzle plate 14 is mechanically (and removably) fixed to the channel substrate 15, and the cover 11 is mechanically (and removably) fixed to the channel substrate 15.

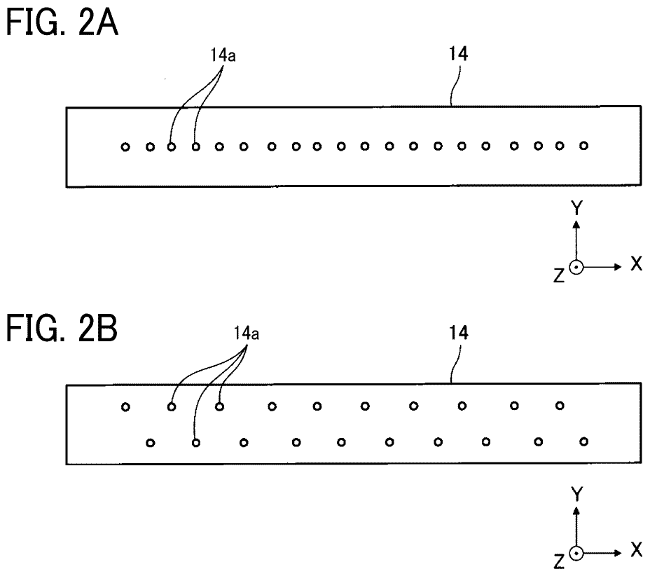

FIGS. 2A and 2B are diagrams each illustrating the arrangement of nozzles 14a of the nozzle plate 14.

As illustrated in FIG. 2A, one nozzle array may be disposed at the center of the nozzle plate 14 in the Y direction (the transverse direction of the liquid discharge head 10). Alternatively, as illustrated in FIG. 2B, two nozzle arrays, in which the nozzles 14a are arrayed in a staggered manner, may be disposed in the Y direction. The arrangements of the nozzles 14a illustrated in FIGS. 2A and 2B are examples. For example, the nozzle plate 14 may have four nozzle arrays in total, i.e., two sets of two nozzle arrays are disposed in the Y direction in a staggered manner. Alternatively, the nozzle plate 14 may have multiple nozzle arrays in which the nozzles 14a are arrayed at the same positions in the X direction (the longitudinal direction of the liquid discharge head 10). In the following description, the liquid discharge head 10 includes the nozzle plate 14 having two nozzle arrays in the Y direction. The nozzles 14a are arrayed in a staggered manner in the nozzle plate 14 as illustrated in FIG. 2B.

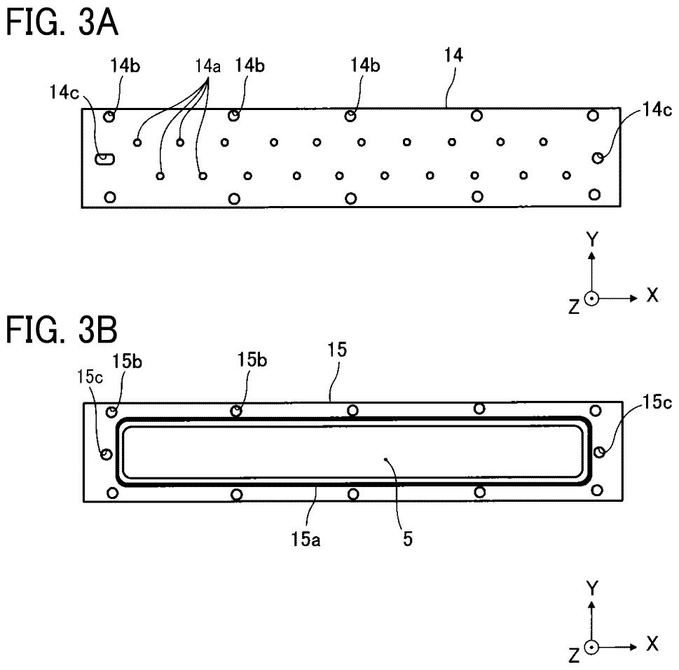

FIGS. 3A and 3B are diagrams illustrating the mechanical fixation of the nozzle plate 14 and the channel substrate 15. FIG. 3A is a schematic diagram illustrating a configuration of the nozzle plate 14, and FIG. 3B is a schematic diagram illustrating a configuration of the channel substrate 15.

The nozzle plate 14 has five through holes 14b, through which screws are inserted, at equal intervals in the X direction at each end of the nozzle plate 14 in the Y direction. Further, the nozzle plate 14 has positioning holes 14c for positioning the nozzle plate 14 with respect to the channel substrate 15 at both ends of the nozzle plate 14 in the X direction. The positioning hole 14c at one end in the X direction is a primary reference for positioning. The positioning hole 14c as the primary reference is a round hole having substantially the same diameter as that of a positioning pin. The positioning hole 14c at the other end in the X direction is a secondary reference for positioning. The positioning hole 14c as the secondary reference is a slotted hole elongated in the X direction.

As illustrated in FIG. 3B, the channel substrate 15 has a channel 5 through which liquid flows. A seal 15a made of an elastic member such as rubber is disposed on the lower face of the channel substrate 15 so as to surround the channel 5. The channel substrate 15 has five female screws 15b, each of which has a screw groove on the inner circumferential face, at equal intervals in the X direction at each end of the lower face of the channel substrate 15 in the Y direction. Further, the channel substrate 15 has pin fitting holes 15c into which the positioning pins are fitted at both ends of the channel substrate 15 in the X direction.

The positioning pins may be formed directly on the channel substrate 15.

First, the positioning pins fitted into the pin fitting holes 15c of the channel substrate 15 are inserted into the positioning holes 14c of the nozzle plate 14 to position the nozzle plate 14 with respect to the channel substrate 15. Then, screws are inserted through the through holes 14b of the nozzle plate 14 and screwed into the female screws 15b of the channel substrate 15 to mechanically (and removably) fix the nozzle plate 14 to the channel substrate 15. The seal 15a on the channel substrate 15 is pressed by screwing the nozzle plate 14 onto the channel substrate 15 to bring the seal 15a into close contact with the nozzle plate 14. As a result, the gap between the nozzle plate 14 and the channel substrate 15 is sealed.

In the present embodiment, since the nozzle plate 14 is fixed to the channel substrate by screwing, the nozzle plate 14 can be easily removed by removing the screws, and the nozzle plate 14 can be easily replaced. Accordingly, for example, the nozzle plate 14 can be replaced with a nozzle plate having nozzles with a desired diameter to obtain optimal discharge properties with respect to a discharge target (i.e., a medium) onto which liquid is discharged.

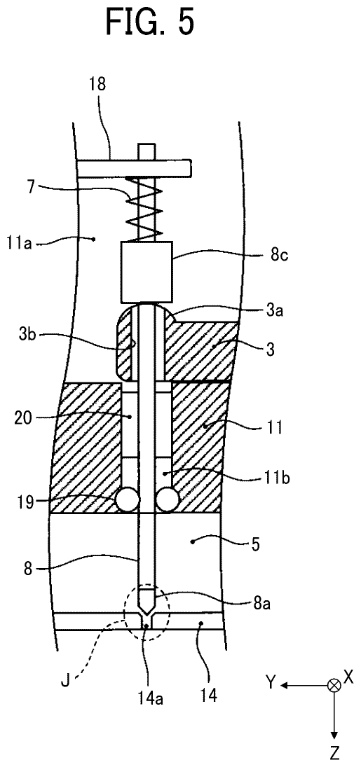

FIG. 4 is a cross-sectional view taken along line A-A in FIG. 1, and FIG. 5 is a partial detailed view of the liquid discharge modules 1.

The cover 11 accommodates multiple liquid discharge modules 1 corresponding to the respective nozzles 14a in a housing portion 11a of the cover 11. The multiple liquid discharge modules 1 are arranged in two rows in a staggered manner. Each of the liquid discharge modules 1 includes a needle valve 8 (i.e., a valve) to open and close the nozzle 14a, and a moving mechanism 6 including an arm 3 and the actuator 2.

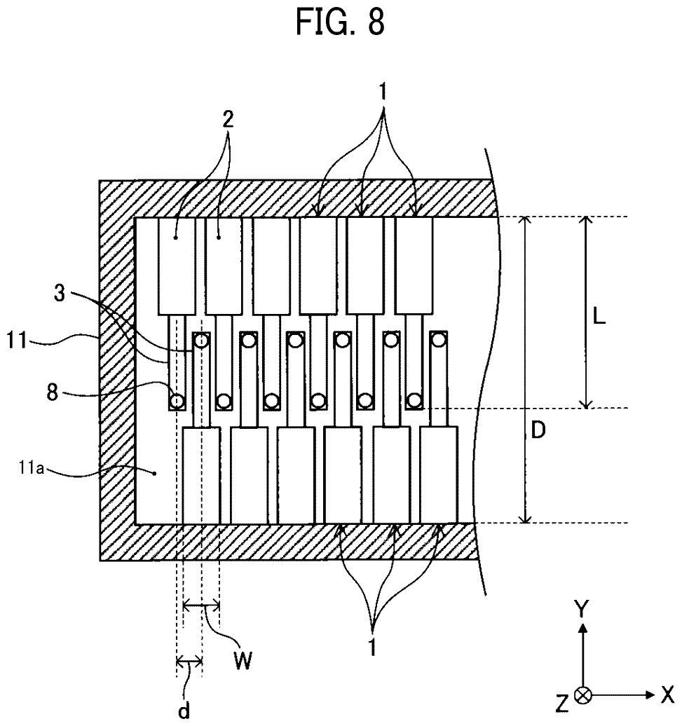

The multiple liquid discharge modules 1 are alternately arranged in the X direction in two rows in the housing portion 11a of the cover 11. The face of the liquid discharge module 1 in one row is diagonally opposite the face of the liquid discharge module 1 in the other row on the side the needle valve 8 is disposed (see FIG. 8 as well). As illustrated in FIG. 4, the arm 3 of the liquid discharge module 1 in one of the two rows partially overlaps the arm 3 of the liquid discharge module 1 in the other row when viewed in the X direction. In the present embodiment, the nozzles 14a are arrayed in a staggered manner in two nozzle arrays of the nozzle plate 14 as illustrated in FIG. 2B. Even when the nozzles 14a are arrayed in one nozzle array of the nozzle plate 14 as illustrated in FIG. 2A, the arm 3 of the liquid discharge module 1 in one of the two rows partially overlaps the arm 3 of the liquid discharge module 1 in the other row when viewed in the X direction.

In the present embodiment, the liquid discharge modules 1 are alternately arranged in two rows. In other words, the liquid discharge modules 1 including the actuator 2 on one side with respect to the nozzle array(s) are diagonally opposite the liquid discharge modules 1 including the actuator 2 on the other side with respect to the nozzle array(s). The liquid discharge modules 1 are alternately arranged in the nozzle array direction such that a part of the arm 3 on the one side overlaps a part of the arm 3 on the other side when viewed in the nozzle array direction.

The actuator 2 includes a piezoelectric element 2a and a holder 2b. The holder 2b fixes the piezoelectric element 2a and applies a preload for compressing the piezoelectric element 2a. The holder 2b is fixed to the inner wall, which is orthogonal to the Y direction, of the housing portion 11a of the cover 11. More specifically, the holder 2b fixes the end of the piezoelectric element 2a in the Z direction to the inner wall of the housing portion 11a. The piezoelectric element 2a expands and contracts in the Z direction. For example, mechanical fixing using screws or chemical fixing such as bonding using an adhesive or thermal diffusion is used to fix the piezoelectric element 2a.

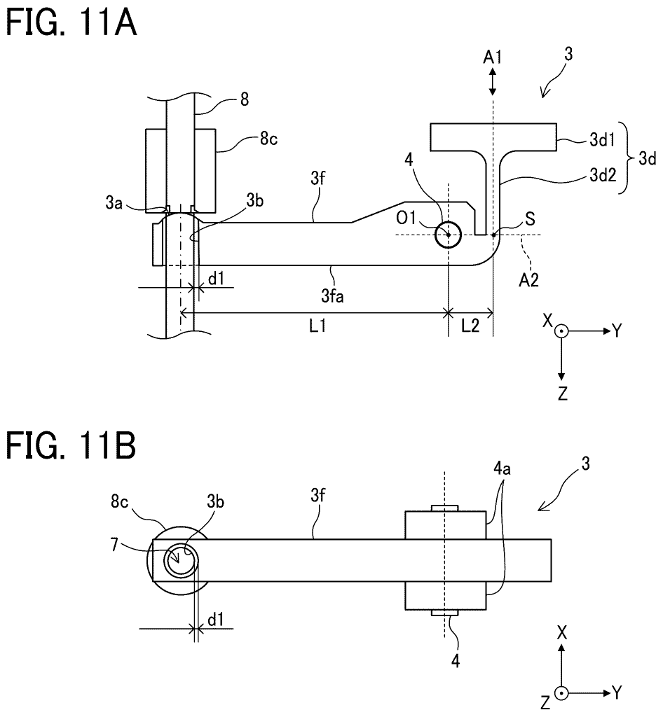

The arm 3 is provided with a support shaft 4, and the support shaft 4 is rotatably supported by an apparatus body via a bearing. The arm 3 has a connection portion 3d (see FIG. 11A) connected to the actuator 2 at one end (i.e., a first end) and a contact portion 3a contacting an arm receiving portion 8c (i.e., a contacted portion of the needle valve 8) fixed to the needle valve 8 at the other end (i.e., a second end). The contact portion 3a is disposed at the other end of the arm 3 (i.e., the second end) and contacts the arm receiving portion 8c. The contact portion 3a has a hemispherical shape or a half-moon shape (i.e., an arc shape) when viewed in the X direction projecting toward the arm receiving portion 8c. Thus, the contact portion 3a smoothly contacts the arm receiving portion 8c when the arm 3 swings.

At the other end of the arm 3, a through hole 3b as a pass-through portion through which the needle valve 8 is inserted is formed. The inner diameter of the through hole 3b is larger than the outer diameter of the needle valve 8 so that the inner circumferential face of the through hole 3b does not contact the outer circumferential face of the needle valve 8 when the arm 3 swings.

Multiple valve through holes 11b through which the needle valves 8 corresponding to the respective nozzles 14a are inserted are disposed in the bottom of the housing portion 11a of the cover 11. A seal 19 such as an O-ring is disposed at an end of the valve through hole 11b adjacent to the channel substrate 15. A valve bearing 20 that slidably bears the needle valve 8 is disposed at the other end of the valve through hole 11b opposite the channel substrate 15. The valve bearing 20 as a restrictor restricts the needle valve 8 from moving in the direction (i.e., an orthogonal direction) orthogonal to an opening and closing direction (i.e., a movement direction) of the needle valve 8. The end of the needle valve 8 opposite the nozzle plate 14 penetrates a spring receiving plate 18. The needle valve 8 is held parallel to the Z direction by the seal 19, the valve bearing 20, and the spring receiving plate 18.

A compression spring 7 as a biasing member is disposed between the arm receiving portion 8c fixed to the needle valve 8 and the spring receiving plate 18 to press the needle valve 8 toward the nozzle plate 14 via the arm receiving portion 8c.

Since the needle valve 8 is pressed toward the nozzle plate 14 by the compression spring 7, the needle valve 8 can be stably moved between an open position at which the nozzle 14a is opened and a closed position at which the nozzle 14a is closed. The spring receiving plate 18 is attached to a coupler 17 fixed to the cover 11.

As illustrated in FIG. 4, the actuators 2 of the liquid discharge modules 1 are connected to a drive control device 30 via the harness. The drive control device 30 includes a waveform generation circuit 31 as a drive pulse generator and an amplification circuit 32.

The waveform generation circuit 31 generates a waveform of a drive pulse described later, and the amplification circuit 32 amplifies the voltage of the waveform to a desired value. The amplified voltage signal is applied to the actuator 2. The drive control device 30 controls the displacement of the piezoelectric element 2a with the voltage applied to the actuator 2 to cause the needle valve 8 to open and close the nozzle 14a. Thus, the liquid discharge head 10 is controlled so as to discharge liquid. When the waveform generation circuit 31 can apply a voltage of a sufficient value, the amplification circuit 32 may be omitted from the drive control device 30.

In the present embodiment, the nozzle 14a is normally closed. The needle valve 8 closes the nozzle 14a by the biasing force of the compression spring 7 when the drive control device 30 applies no signal to the actuator 2. The phrase “no signal is applied to the actuator 2” means that either a voltage of 0 V or a constant static voltage is constantly applied to the actuator 2.

The waveform generation circuit 31 generates the drive pulse having the waveform in which the voltage applied to the actuator 2 is changed with time. The waveform generation circuit 31 receives, for example, print data from an external personal computer (PC) or a microcomputer in a liquid discharge apparatus, and generates a drive pulse based on the received print data. The waveform generation circuit 31 can change the voltage applied to the actuator 2 and generate multiple drive pulses. As described above, the waveform generation circuit 31 generates the drive pulse, and the piezoelectric element 2a of the actuator 2 expands and contracts in accordance with the drive pulse.

Specifically, the piezoelectric element 2a expands when a predetermined voltage is applied to the piezoelectric element 2a. When the piezoelectric element 2a expands, the arm 3 swings in a direction in which the other end (i.e., the second end) of the arm 3 lifts the arm receiving portion 8c. As a result, the arm receiving portion 8c is moved upward (toward the spring receiving plate 18) against the biasing force of the compression spring 7, and the needle valve 8 is moved upward together with the arm receiving portion 8c. As a result, the nozzle 14a is opened, and liquid droplets (i.e., a liquid) are discharged from the nozzle 14a by the pressure applied to the liquid in the channel 5.

As the voltage applied to the piezoelectric element 2a decreases, the piezoelectric element 2a contracts. When the piezoelectric element 2a contracts, the arm 3 swings such that the other end (i.e., the second end) of the arm 3 is moved downward (toward the nozzle plate 14). Thus, the arm receiving portion 8c is also moved downward by the biasing force of the compression spring 7, following the movement of the other end of the arm 3. As a result, the nozzle 14a is closed by the needle valve 8 to stop discharging the liquid droplets from the nozzle 14a.

In the present embodiment, the piezoelectric element 2a is used as the actuator 2, but the actuator 2 may be any actuator driven by electricity, such as a pneumatic piston provided with a solenoid or an electromagnetic valve. Further, in the present embodiment, the compression spring 7 is used, but a tension spring for pulling the needle valve 8 toward the nozzle plate 14 may be used. In this case, for example, one end of the tension spring may be fixed to the bottom face of the housing portion 11a, and the other end of the tension spring may be fixed to the needle valve 8 or the arm receiving portion 8c with the tension spring extended.

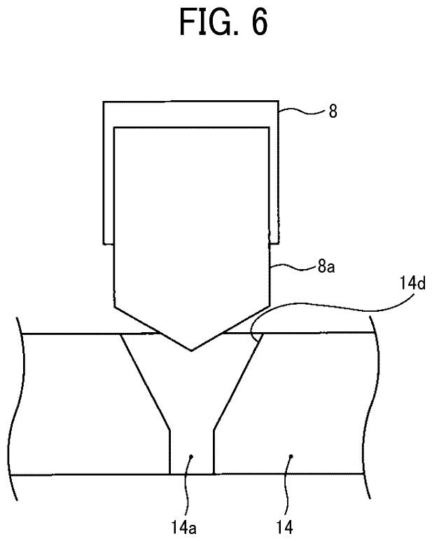

FIG. 6 is an enlarged view of a portion surrounded by broken line J in FIG. 5.

As illustrated in FIG. 6, a sealing member 8a is disposed at the tip of the needle valve 8. The sealing member 8a is made of elastomer, hard rubber, metals, or ceramics. The needle valve 8 and the sealing member 8a may be formed as a single piece. The sealing member 8a contacts a channel opening-closing portion 14d of the nozzle plate 14. The sealing member 8a and the channel opening-closing portion 14d may be subjected to ceramic coating or diamond-like coating to enhance slidability or durability.

The tip of the sealing member 8a has a needle shape with a tapered cross section, and the channel opening-closing portion 14d of the nozzle plate 14 also has a funnel shape with a tapered cross section. However, such shapes are examples. The tip of the sealing member 8a may have a smooth convex curved surface such as a spherical shape, and the channel opening-closing portion 14d of the nozzle plate 14 may have a smooth concave curved surface that tightly contacts the smooth convex curved surface of the tip of the sealing member 8a. Alternatively, the tip of the sealing member 8a may have a flat surface, and the tip of the sealing member 8a may contact the periphery of an inlet of the nozzle 14a to close the nozzle 14a.

The nozzle plate 14 may include multiple layers including a layer having the nozzle 14a and a layer having the channel opening-closing portion 14d. In this case, the layers of the nozzle plate 14 have a structure for defining the positions thereof to firmly fix the layers to each other by chemical fixing such as bonding by adhesion or joining by thermal diffusion to prevent liquid from leaking from between the layers.

When the sealing member 8a is pressed against the channel opening-closing portion 14d by the biasing force of the compression spring 7, the sealing member 8a disposed at the tip of the needle valve 8 tightly contacts the channel opening-closing portion 14d to reliably close the nozzle 14a.

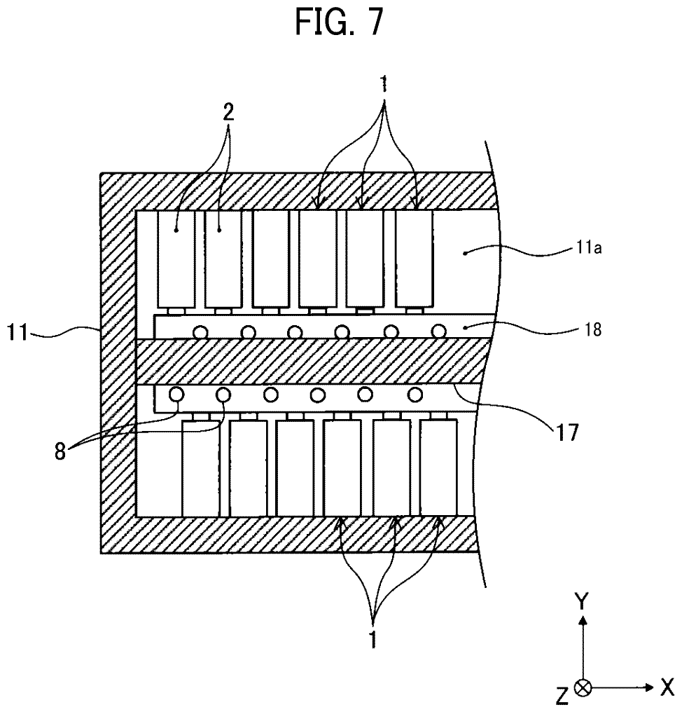

FIG. 7 is a schematic diagram illustrating a part of a cross section taken along line B-B in FIG. 4.

As illustrated in FIG. 7, the spring receiving plate 18 is attached to the lower end of the coupler 17. The coupler 17 extends in the X direction (longitudinal direction of the liquid discharge head 10) of the cover 11, and is bridged between a pair of inner walls of the cover 11 orthogonal to the X direction. Thus, the coupler 17 is fixed to the cover 11.

The spring receiving plate 18 is disposed between the actuator 2 positioned on one side (left side in FIG. 4) with respect to the arrangement of the nozzles 14a and the actuator 2 positioned on the other side (right side in FIG. 4) when viewed in the nozzle array direction (X direction) in FIG. 4. In the present embodiment, the actuator 2 and the needle valve 8 are connected by the arm 3. Accordingly, the actuator 2 and the needle valve 8 are arranged so as not to overlap each other when viewed in the movement direction (Z direction, i.e., a first direction) of the needle valve 8. Due to such an arrangement, in the present embodiment, the spring receiving plate 18 can be disposed in a space in the vicinity of the needle valve 8, i.e., in the space above the needle valve 8 in the Z direction in FIG. 4. With such a configuration, the size of the liquid discharge head 10 in the Y direction and the size of the liquid discharge head 10 in the Z direction can be reduced.

In the present embodiment, the actuator 2, which is the largest component among the components constructing the liquid discharge module 1, can be disposed at the end in the Y direction in the housing portion 11a due to the arm 3. Thus, as illustrated in FIGS. 4 and 7, the coupler 17 can be disposed at the center in the Y direction in the housing portion 11a, and the spring receiving plate 18 can be fixed by the single coupler 17. For example, when the actuator 2 is disposed at the center in the Y direction without the arm 3, both ends of the spring receiving plate 18 in the Y direction or both ends of the spring receiving plate 18 in the X direction are held by two couplers 17, respectively. In this way, when the actuator 2 is disposed at the center in the Y direction, the two couplers 17 may increase the size of the liquid discharge head 10 in the X direction or the Y direction. Further, the spring receiving plate 18 may be extended to a position not facing the actuator 2, and thus the size of the spring receiving plate 18 may also be increased.

By contrast, in the present embodiment, the spring receiving plate 18 can be held by the single coupler 17 disposed at the center in the Y direction in the housing portion 11a, and thus the size of the liquid discharge head 10 can be reduced. Further, the spring receiving plate 18 extended to a position not facing the actuator 2 is unnecessary, and thus the size of the spring receiving plate 18 can be reduced. Furthermore, the arm 3 allows the actuator 2 to be disposed at the end in the Y direction in the housing portion 11a, and thus the distance between the nozzle arrays in the Y direction can be shortened. Accordingly, the length of the spring receiving plate 18 in the Y direction can be further shortened, the material cost can be reduced, and the cost of the liquid discharge head 10 can be reduced.

FIG. 8 is a schematic diagram illustrating a part of a cross section taken along line C-C in FIG. 4. In FIG. 8, the illustrations of the arm receiving portion 8c and the compression spring 7 are omitted.

A group of the liquid discharge modules 1 arranged on the upper side of FIG. 8 (one side in the Y direction, e.g., a first side) corresponds to a nozzle array arrayed on the lower side of FIG. 8 (the other side in the Y direction, e.g., a second side) in the nozzle plate 14. A group of the liquid discharge modules 1 arranged on the lower side of FIG. 8 (the other side in the Y direction, e.g., the second side) corresponds to a nozzle array arrayed on the upper side of FIG. 8 (the one side in the Y direction, e.g., the first side) in the nozzle plate 14.

In the present embodiment, as illustrated in FIG. 4, the liquid discharge modules 1 are alternately arranged in the X direction, and the arm 3 of the liquid discharge module 1 on the one side partially overlaps the arm 3 of the liquid discharge module 1 on the other side when viewed in the X direction. Thus, a length D of the housing portion 11a of the cover 11 in the Y direction is smaller than twice a length L of the liquid discharge module 1 in the Y direction (i.e., D<2L). In this way, the arms 3 partially overlap each other. As a result, the length D of the housing portion 11a of the cover 11 in the Y direction is less than twice the length L of the liquid discharge module 1 in the Y direction, and thus the liquid discharge head 10 can be downsized in the Y direction. The length L of the liquid discharge module 1 in the Y direction is defined as the longer distance of the horizontal distances from the back face of the actuator 2 fixed to the inner wall of the cover 11 either to the end face of the needle valve 8 in the Y direction (the longitudinal direction of the arm 3) or to the end face of the arm 3 farthest from the actuator 2.

In the present embodiment, the arm 3 allows the actuator 2 to be disposed at the end in the Y direction in the housing portion 11a. As illustrated in FIG. 8, the width (length in the X direction) of the arm 3 is narrower than the width (length in the X direction) of the actuator 2. Accordingly, when the liquid discharge modules 1 are alternately arranged in the X direction, the arm 3 and a part of the actuator 2 of the liquid discharge module 1 on the one side overlaps a part of the actuator 2 of the liquid discharge module 1 on the other side when viewed in the Y direction. As a result, a nozzle pitch d can be shorter than a width W (length in the X direction) of the liquid discharge module 1 (i.e., d<W), the nozzle pitch d can be narrowed, and thus the liquid discharge head 10 can be downsized in the X direction.

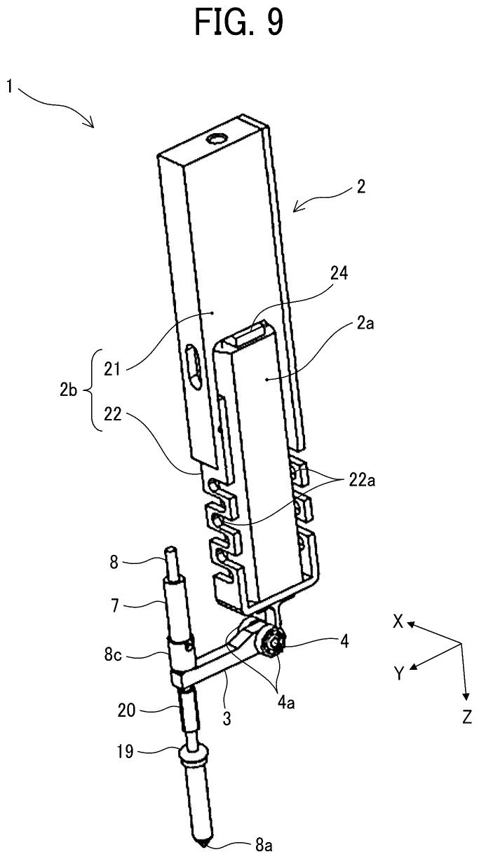

FIG. 9 is a perspective view of the liquid discharge module 1.

The actuator 2 includes a piezoelectric element 2a and a holder 2b holding the piezoelectric element 2a. The holder 2b includes a fixing holder 21 and a biasing holder 22. The biasing holder 22 has spring portions 22a on a pair of side faces orthogonal to the Y direction. The biasing holder 22 is fixed to the fixing holder 21 by, for example, adhesion. The piezoelectric element 2a is sandwiched between the biasing holder 22 and the fixing holder 21 in the Z direction. The piezoelectric element 2a is held by the holder 2b such that the piezoelectric element 2a is compressed in the Z direction by the biasing force of the spring portion 22a of the biasing holder 22 while being sandwiched between the biasing holder 22 and the fixed holder 21. Thus, the piezoelectric element 2a is firmly accommodated in the holder 2b, and is stabilized when moving in an expansion and contraction direction (the displacement in the Z direction).

In the present embodiment, the fixing holder 21 includes a pushing element such as a setscrew. The pushing element pushes the piezoelectric element 2a via a biasing receiver 24 which contacts the upper face of the piezoelectric element 2a to adjust a pushing amount of the piezoelectric element 2a toward the nozzle 14a. The pushing element adjusts the position of the piezoelectric element 2a in the expansion and contraction direction (i.e., a displacement direction) to correct the dimensional variations of the piezoelectric element 2a in the expansion and contraction direction (Z direction). As the pushing amount of the piezoelectric elements 2a is adjusted by the pushing element, the spring portion 22a expands or contracts, and thus the biasing force (compressive force) applied to the piezoelectric element 2a is adjusted. A sheet metal having high durability such as a steel use stainless (SUS) sheet is processed to form the biasing holder 22. For example, slits are formed in the sheet metal alternately in the X direction by wire electrical discharge machining (EDM) to form the biasing holder 22 having a crankshaft shape (zigzag).

One end (i.e., the first end) of the arm 3 is connected to the bottom face of the biasing holder 22. The spring portion 22a of the biasing holder 22 expands and contracts following the expansion and contraction of the piezoelectric element 2a in the Z direction to push and pull the one end of the arm 3 so as to swing the arm 3.

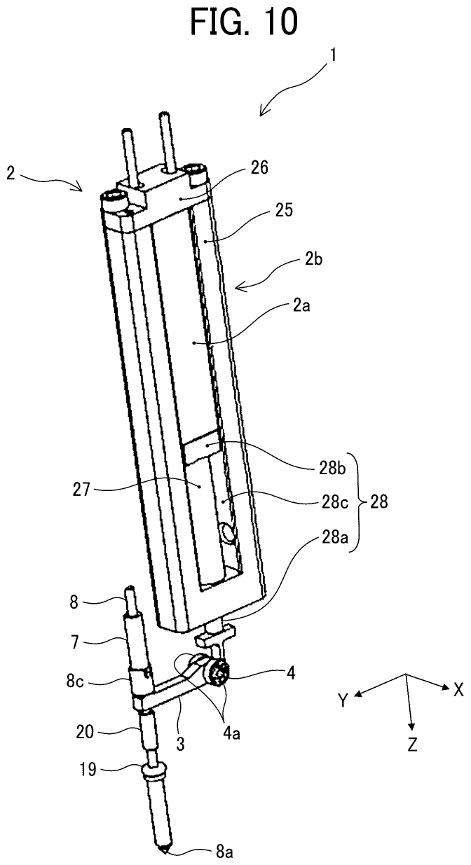

FIG. 10 is a perspective view of the liquid discharge module 1 including the actuator 2 provided with a holder 2b according to a modification.

As illustrated in FIG. 10, the holder 2b according to the present modification includes a holder body 25, a lid 26, a holder spring 27, and an actuator lever 28. The lid 26 is fixed to the holder body 25 by a fastening member such as a screw to accommodate the piezoelectric element 2a, the holder spring 27, and the actuator lever 28 in the holder body 25.

The actuator lever 28 has an element contact portion 28b contacting the lower face of the piezoelectric element 2a, and a pin-shaped arm connection portion 28a connected to the one end (i.e., the first end) of the arm 3. The arm connection portion 28a is inserted through a hole formed in the bottom of the holder body 25. The element contact portion 28b and the arm connection portion 28a are connected by a plate-shaped connection side face portion 28c facing the holder spring 27 in the Y direction.

The holder spring 27 is a coil spring and is accommodated in the holder body 25 in a compressed state. The upper end of the holder spring 27 contacts the element contact portion 28b of the actuator lever 28, and the lower end of the holder spring 27 contacts a spring receiver disposed in the holder body 25. Thus, the piezoelectric element 2a receives the biasing force of the holder spring 27 via the element contact portion 28b and is held between the element contact portion 28b and the lid 26 in a compressed state in the holder body 25. Accordingly, the piezoelectric element 2a according to the present modification is firmly accommodated in the holder 23, and is stabilized when moving in the expansion and contraction direction (the displacement in the Z direction).

Components (e.g., the holder 2b and the actuator lever 28) surrounding the piezoelectric elements 2a of the actuators 2 illustrated in FIGS. 9 and 10 are made of, for example, aluminum, copper, or SUS 304. These surrounding components are made of a material having a thermal expansion coefficient of about 17×10⁻⁶/° C. or more and a high thermal conductivity.

The piezoelectric element 2a may generate significant heat when operated at high duty cycles. The piezoelectric element 2a has a property of shrinking due to a temperature rise. The components (e.g., the holder 2b and the actuator lever 28), surrounding the piezoelectric element 2a, made of a material having a high thermal conductivity can facilitates the heat dissipation from the piezoelectric element 2a. Such a configuration allows the piezoelectric element 2a to operate stably over a wide temperature range, at high frequencies, and with aggressive waveforms.

The compression springs 7 presses the arm receiving portion 8c so that the sealing member 8a at the tip of the needle valve 8 is pressed against the nozzle 14a with a load sufficient to prevent liquid from leaking from the nozzle 14a when the needle valve 8 is positioned at the closed position at which the nozzle 14a is closed. The seal 19 receives a force in a direction away from the nozzle 14a from the pressurized liquid in the channel 5.

As a result, the force in the direction away from the nozzle 14a is applied to the needle valve 8. For this reason, the biasing force of the compression spring 7 is greater than the resultant of the above-described load and the force, received by the seal 19, in the direction to separate the needle valve 8 from the nozzle 14a. In the present embodiment, as will be described later, the displacement of the actuator 2 is amplified by the arm 3 to move the needle valve 8. The force to move the needle valve 8 to the open position against the biasing force of the compression spring 7 is amplified by the arm 3. Accordingly, in the actuator 2, the rigidity of the piezoelectric element 2a and the rigidity of the holder 2b holding the piezoelectric element 2a are designed to generate the force for moving the needle valve 8 against the biasing force of the compression spring 7 amplified by the arm 3.

The arm 3, which is the feature of the present embodiment, will be described below in detail.

FIGS. 11A and 11B are schematic views of the arm 3. FIG. 11A is a cross-sectional view of the arm 3 as viewed in the X direction, and FIG. 9B is a view of the arm 3 as viewed in the Z direction (from the nozzle side).

The arm 3 has the connection portion 3d at one end (i.e., the first end) and the contact portion 3a at the other end (i.e., the second end). The actuator 2 is bonded and fixed onto the connection portion 3d. The contact portion 3a contacts the arm receiving portion 8c. The support shaft 4 is disposed between the center of the arm 3 and the connection portion 3d in the longitudinal direction of the arm 3 (Y direction, i.e., a second direction). The support shaft 4 has a swing axis extending a swing axis direction (i.e., a third direction) orthogonal to the movement direction of the needle valve 8 and the longitudinal direction of the arm 3, and the arm 3 is swung about the swing axis.

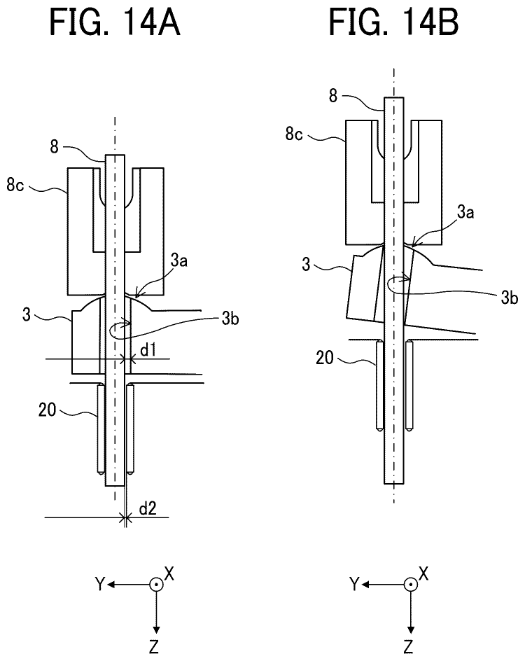

As described above, the contact portion 3a projects in the direction (−Z direction) opposite to the liquid discharge direction, and the contact surface contacting the arm receiving portion 8c has the arc shape when viewed in the X direction as illustrated in FIG. 11A. As illustrated in FIG. 11B, a through hole 3b through which the needle valve 8 is inserted is disposed in the center of the contact portion 3a. As described above, the through hole 3b has an inner diameter larger than the outer diameter of the needle valve 8, and a clearance d1 is formed between the inner circumferential face (i.e., an arm side face) of the through hole 3b and the outer circumferential face of the needle valve 8 so that the needle valve 8 does not contact the arm 3 when the arm 3 is swung. As illustrated in FIG. 14A, the clearance d1 is larger than a clearance d2 between the valve bearing 20 and the outer circumferential face of the needle valve 8.

The connection portion 3d has a bonding face 3d1 and a connector 3d2. The bonding face 3d1 is orthogonal to the Z direction and has a rectangular shape. The connector 3d2 extends in the Z direction and connects the bonding face 3d1 and a body 3f of the arm 3. The connector 3d2 is flexibly deformable. As illustrated in FIG. 11A, a connected position S of the connector 3d2 with the body 3f of the arm 3 is aligned with a center O1 of the swing (i.e., the swing axis) of the arm 3 in the Z direction. Thus, a straight 20 line A2 passing through the center O1 of the swing of the arm 3 and the connected position S of the connector 3d2 is orthogonal to displacement directions A1 of the actuator 2.

When the actuator 2 is in the OFF state and the straight line A2 passing through the center O1 of the swing of the arm 3 and the connected position S of the connector 3d2 is not orthogonal to the displacement directions A1 of the actuator 2, the pressing force applied to the arm 3 by the displacement of the actuator 2 is as follows. The pressing force is divided into a vector component for swinging the arm 3 in the direction orthogonal to the straight line A2 passing through the center O1 of the swing of the arm 3 and the connected position S of the connector 3d2 and a vector component in the direction along the straight line A2. As a result, all of the pressing force of the actuator 2 is not used as the force for swinging the arm 3.

On the other hand, as in the present embodiment, when the straight line A2 passing through the center O1 of the swing of the arm 3 and the connected position S of the connector 3d2 is orthogonal to the displacement directions A1 of the actuator 2, all of the pressing force applied to the arm 3 by the displacement of the actuator 2 can be used as the force for swinging the arm 3. Thus, the displacement of the actuator 2 can be efficiently used for the swing of the arm 3, and the arm 3 can be swung well against the biasing force of the compression spring 7.

If the positional difference in the Z direction (displacement direction of the actuator 2) between the connected position S of the connector 3d2 with the body 3f of the arm 3 and the center O1 of the swing of the arm 3 is as described below, the vector component in the direction along the straight line A2 is small, and the arm 3 can be swung well. The positional difference between the connected position S and the center O1 of the swing of the arm 3 in the Z direction (displacement direction of the actuator 2) is smaller than the amount of displacement of the piezoelectric element 2a.

The actuator 2 is bonded and fixed to the bonding face 3d1 of the arm 3. As described above, the arm 3 has the rectangular bonding face 3d1 orthogonal to the Z direction. Thus, the adhesive area on the bonding face 3d1 to the piezoelectric element 2a is increased, and the arm 3 can be firmly fixed to the piezoelectric element 2a. In addition, the influence on the displacement due to the variations in the bonding position of the piezoelectric element 2a can be reduced.

When the bonding face 3d1 is displaced in the Z direction together with the actuator 2 by the displacement of the actuator 2, the arm 3 is swung about the support shaft 4 (i.e., the swing axis). The swing of the arm 3 generates force that inclines the bonding face 3d1 with the left end in FIG. 11A positioned upward. At this time, the connector 3d2, which is bendable, is deformed (bent), and thus the force for inclining the bonding face 3d1 is absorbed. As a result, the arm 3 can be smoothly swung. Thus, the needle valve 8 can be stably displaced, and the variations of the liquid droplets can be reduced.

In the arm 3, the support shaft 4 is disposed between the center of the arm 3 and the connection portion 3d in the longitudinal direction of the arm 3 (Y direction). In other words, a length L2 from the support shaft 4 to the connection portion 3d is shorter than a length L1 from the support shaft 4 to the contact portion 3a in the longitudinal direction of the arm 3. Accordingly, the radius of swing of the contact portion 3a is longer than the radius of swing of the connection portion 3d, and the displacement of the contact portion 3a in the Z direction is larger than the displacement of the connection portion 3d in the Z direction. Thus, the displacement of the arm receiving portion 8c lifted by the contact portion 3a in the Z direction is larger than the displacement of the actuator 2 in the Z direction. As a result, the arm 3 amplifies the displacement of the actuator 2, and the amount of movement of the needle valve 8 can be increased. In other words, the arm 3 moves the needle valve 8 by the amplified displacement. Accordingly, the gap between the nozzle 14a and the sealing member 8a when the needle valve 8 is in the open position can be increased, liquid having high viscosity easily flows into the nozzle 14a, and the size of the liquid droplets discharged from the nozzle 14a can be increased. Thus, printing efficiency can be increased, and printing time can be shortened. In addition, the actuator 2 which is displaced by a small amount can be used, the actuator 2 can be downsized, and the liquid discharge head 10 can be effectively downsized.

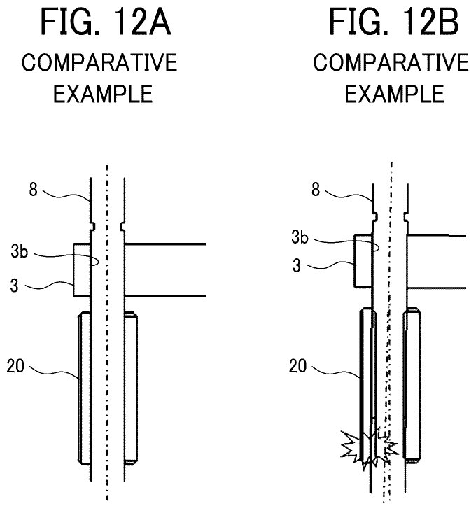

FIGS. 12A and 12B are diagrams illustrating a configuration of a part of an arm 3 according to a comparative example.

As illustrated in FIGS. 12A and 12B, the needle valve 8 is inserted through a through hole 3b of the arm 3 and fitted (fixed) into the through hole 3b. The inner circumferential face of the through hole 3b and the outer circumferential face of the needle valve 8 are in close contact with each other. In this configuration, when the arm 3 is swung by the driving of the actuator 2, as illustrated in FIG. 12B, the needle valve 8 moves in a direction away from the nozzle 14a while tilting toward the right in FIG. 12B at the upper end thereof (toward the body 3f of the arm 3). As a result, as illustrated in FIG. 12B, the needle valve 8 may collide with the valve bearing 20, and thus the needle valve 8 is hindered from moving to the open position. In the worst case, the needle valve 8 may not move to the open position or may be broken.

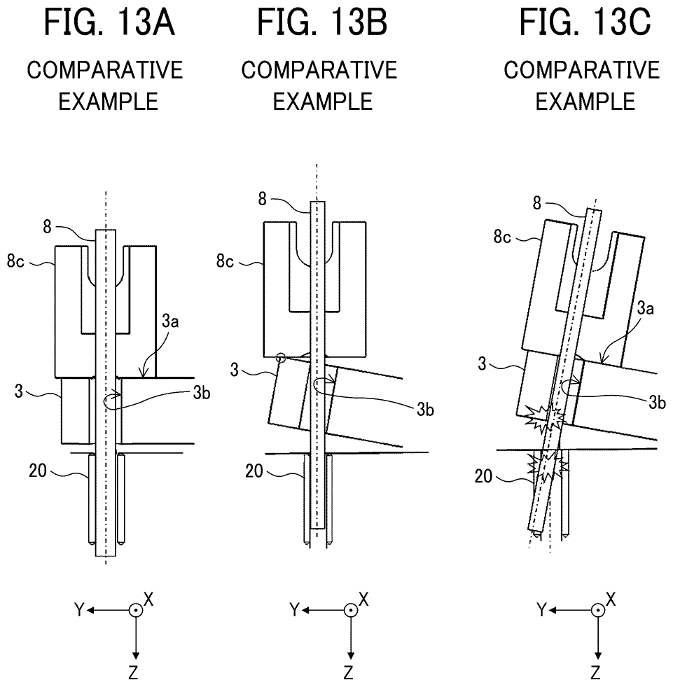

FIGS. 13A to 13C are diagrams illustrating a configuration of a part of an arm 3 according to a comparative example. When the contact portion 3a of the arm 3 contacting the arm receiving portion 8c is flat as illustrated in FIG. 13A, the lower face of the arm receiving portion 8c is in surface contact with the contact portion 3a of the arm 3 in the OFF state of the actuator 2 as illustrated in FIG. 13A. As illustrated in FIG. 13B, when a voltage is applied to the piezoelectric element 2a and the arm 3 starts to swing clockwise in FIG. 13B, the arm 3 contacts the left side of the arm receiving portion 8c in FIG. 13B. Accordingly, as illustrated in FIG. 13C, the arm receiving portion 8c is tilted by the biasing force of the compression spring 7 to follow the tilt of the arm 3, and the needle valve 8 fixed to the arm receiving portion 8c is tilted together with the arm receiving portion 8c. As a result, the needle valve 8 may collide with the inner circumferential face of the through hole 3b of the arm 3 or the valve bearing 20.

FIGS. 14A and 14B are schematic diagrams illustrating the contact portion 3a of the arm 3 and the surroundings thereof. FIG. 14A illustrates the contact portion 3a of the arm 3 and the surroundings thereof when the needle valve 8 is located at the closed position, and FIG. 14B illustrates the contact portion 3a of the arm 3 and the surroundings thereof when the needle valve 8 is located at the open position.

In the present embodiment, as described above, the inner diameter of the through hole 3b is larger than the outside diameter of the needle valve 8, and the clearance d1 is formed between the inner circumferential face (i.e., the arm side face) of the through hole 3b and the outer circumferential face of the needle valve 8. Such a configuration prevents the inner circumferential face of the through hole 3b from colliding with the needle valve 8 when the arm 3 is swung, and thus the needle valve 8 is not hindered from moving to the open position. As a result, the needle valve 8 can be stably moved between the open position and the closed position, and the liquid droplets can be favorably discharged from the nozzle 14a.

In the arm 3, the contact portion 3a projects in the direction (−Z direction) opposite to the liquid discharge direction, and the contact surface contacting the arm receiving portion 8c has the arc shape when viewed in the X direction.

As illustrated in FIG. 14A, before the arm 3 is swung, the top of the contact portion 3a is in contact with the center of the arm receiving portion 8c in the left-right direction in FIG. 14A (Y direction). When the arm 3 is swung, the contact position of the contact portion 3a with the arm receiving portion 8c is shifted to the left as illustrated in FIG. 14B (toward the second end of the arm 3). At this time, since the contact surface of the contact portion 3a with the arm receiving portion 8c has the arc shape when viewed in the X direction, the contact position of the arm receiving portion 8c with the contact portion 3a hardly changes with the swing of the arm 3. Accordingly, the arm 3 can be kept in contact with the central portion of the arm receiving portion 8c in the left-right direction in FIG. 14B (Y direction). Such a configuration can prevent the arm receiving portion 8c from being tilted with respect to the Z direction by the biasing force of the compression spring 7, and the needle valve 8 can be prevented from colliding with the inner circumferential face of the through hole 3b and the valve bearing 20. As a result, the needle valve 8 can be prevented from being hindered from moving to the open position, and can be stably moved between the open position and the closed position, so that the liquid droplets can be favorably discharged from the nozzle 14a. The central portion of the arm receiving portion 8c where the contact portion 3a of the arm 3 is in contact with is preferably within a range from the center of the needle valve 8 to the outer diameter of the needle valve 8 when viewed in the X direction. The contact position between the arm receiving portion 8c and the contact portion 3a within the range of the outer diameter of the needle valve 8 (i.e., the contact position remaining in contact with the central portion) when viewed in the X direction can prevent the needle valve 8 from being tilted.

Further, the contact portion 3a having the arc shape allows the contact position of the contact portion 3a with the arm receiving portion 8c to be smoothly shifted, and thus the arm 3 can be smoothly swung. Thus, the needle valve 8 can be stably displaced, and the variations of the liquid droplets can be reduced.

As illustrated in FIG. 11A, a bottom face 3fa of the body 3f of the arm 3 is flat. When the liquid discharge module 1 is assembled, the arm 3 is placed on a reference surface of a reference member such as a block gauge and set in an initial posture (posture when the actuator 2 is in the OFF state). The body 3f having the flat bottom face 3fa prevents the arm 3 from being tilted with respect to the reference surface when the liquid discharge module 1 is assembled. Thus, the arm 3 can be prevented from being assembled to the liquid discharge module 1 with a tilted posture from the intended initial posture. As a result, the liquid discharge module 1 can be accurately assembled such that the straight line A2 of the arm 3 is orthogonal to the displacement directions A1 of the actuator 2 when the actuator 2 is in the OFF state. Further, the clearance d1 between the inner circumferential face of the through hole 3b and the outer circumferential face of the needle valve 8 is not partially narrowed.

The body 3f of the arm 3 is designed to have a sufficient moment of inertia of area in the direction of swing of the arm 3 so that the body 3f is not bent (deformed) when the actuator 2 is displaced. The deformation of the body 3f of the arm 3 causes a loss of the displacement of the actuator 2.

In the present embodiment, the arm 3 is formed of SUS 440. The SUS 440 is a martensitic stainless steel which is hardened by quenching and tempering and is good in strength, hardness, and wear resistance. The arm 3 formed of SUS 440, which is good in strength and hardness, can have a sufficient moment of inertia of area in the direction of swing of the arm 3. The arm 3 formed of SUS 440, which is good in strength, can extend the life of the connector 3d2 that is flexibly deformed. The thermal expansion coefficient of the SUS 440 is about 10×10⁻⁶/° C.

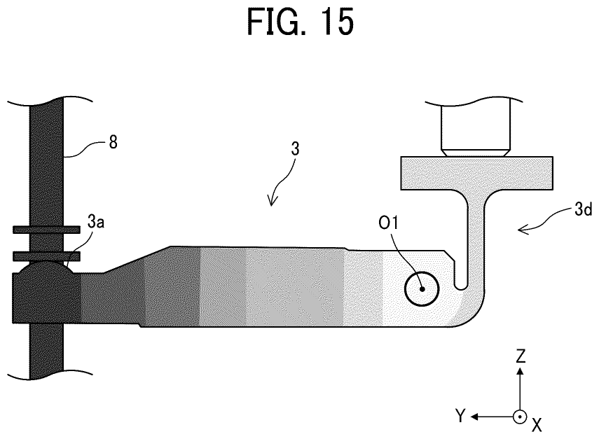

FIG. 15 is a diagram illustrating a displacement distribution of the arm 3 in the Z direction when the actuator 2 is driven. In FIG. 15, the darker color indicates the larger displacement in the Z direction.

As illustrated in FIG. 15, the arm 3 having the above-described configuration can be swung favorably, and the displacement in the Z direction can be larger at a position farther away from the center of swing of the arm 3. As can be seen from the displacement distribution in FIG. 15, the amount of displacement in the Z direction is larger near the contact portion 3a at the other end (i.e., the second end) of the arm 3 than near the connection portion 3d at the one end (i.e., the first end) of the arm 3. In other words, the arm 3 amplifies the displacement of the actuator 2 and moves the needle valve 8 by the amplified displacement.

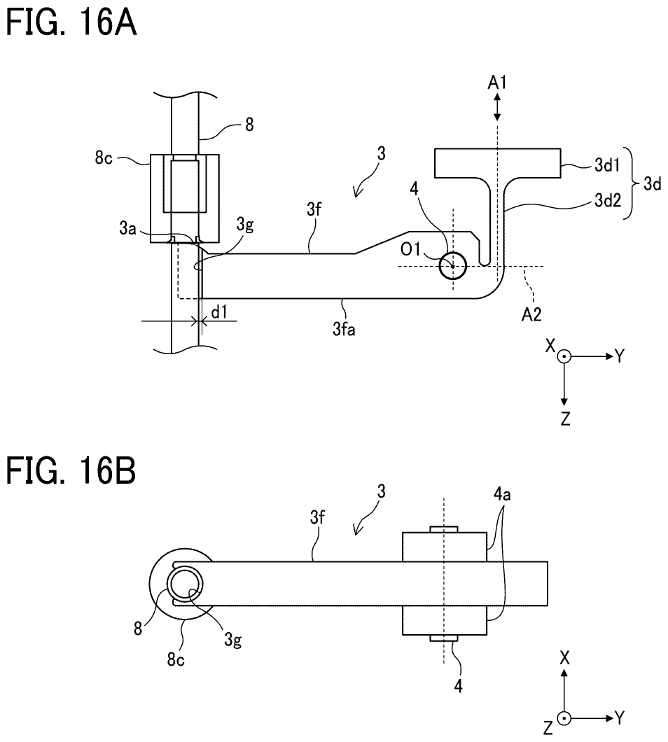

FIGS. 16A and 16B are schematic views of the arm 3 according to a modification. FIG. 16A is a cross-sectional view of the arm 3 as viewed in the X direction, and FIG. 16B is a view of the arm 3 as viewed in the Z direction (from the nozzle side).

In the arm 3 according to the present modification, the pass-through portion through which the needle valve 8 is inserted is a pass-through groove 3g. In this modification, the side face (i.e., the arm side face) of the pass-through groove 3g faces the outer circumferential face of the needle valve 8 with a clearance d1 therebetween. Thus, when the arm 3 is swung by the displacement of the actuator 2, the side face of the pass-through groove 3g can be prevented from colliding with the needle valve 8, and the needle valve 8 can be smoothly moved. In this modification, a part of the outer circumferential face of the needle valve 8 is exposed from the pass-through groove 3g. In other words, another part of the outer circumferential face of the needle valve 8 is fitted into the pass-through groove 3g.

In the present embodiment, since the pass-through groove 3g is formed such that the part of the outer circumferential face of the needle valve 8 is exposed from the pass-through groove 3g, the needle valve 8 can be easily fitted (inserted) into the pass-through groove 3g of the arm 3 in the Y direction (i.e., from the left side in FIGS. 16A and 16B). The configuration illustrated in FIGS. 16A and 16B facilitates the attachment of the needle valve 8 to the arm 3 (even when the needle valve 8 is long) in the lateral direction (Y direction) as compared with the configuration illustrated in FIGS. 11A and 11B in which the needle valve 8 is inserted into the through hole 3b in the Z direction.

### Modification

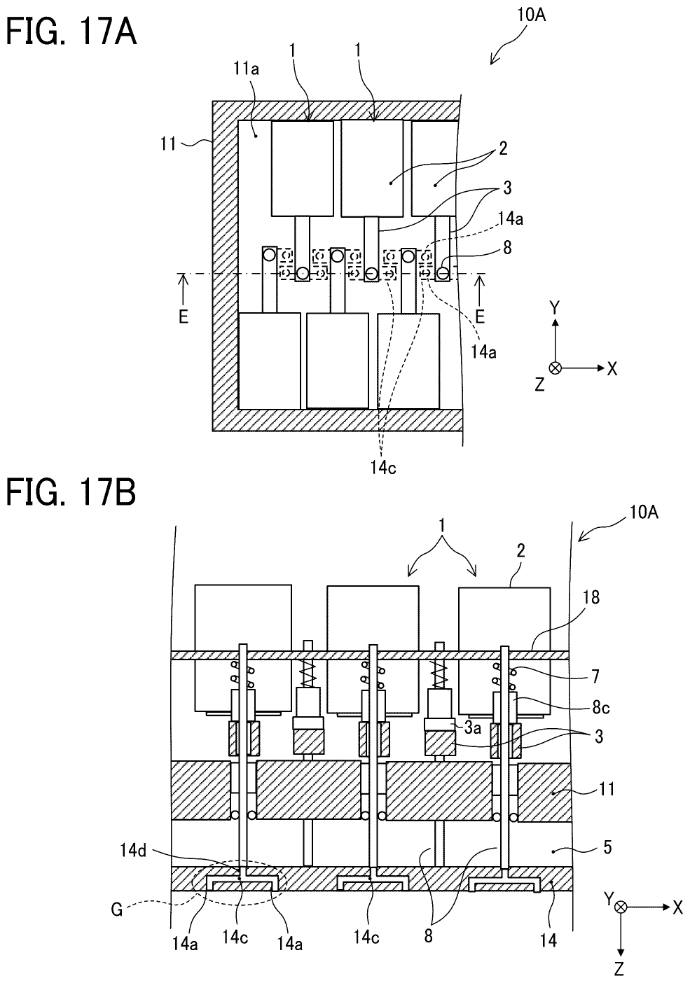

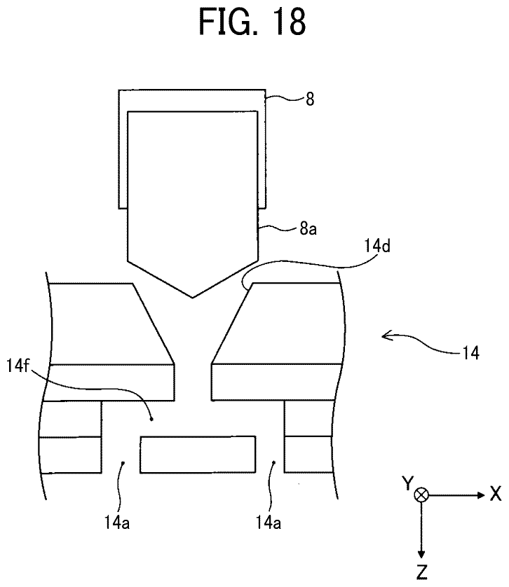

FIGS. 17A and 17B are schematic views of a part of a liquid discharge head 10A according to a modification. FIG. 17A is a view when viewed in the Z direction, and FIG. 17B is a cross-sectional view taken along line E-E in FIG. 17A. FIG. 18 is an enlarged view of a portion indicated by broken line G in FIG. 17B.

The liquid discharge head 10A according to the present modification has a configuration in which the needle valve 8 opens and closes the multiple nozzles 14a. In this modification, as illustrated in FIG. 17A, the nozzle plate 14 has the nozzles 14a arrayed in the Y direction, i.e., in two rows and two columns.

As illustrated in FIG. 17, the nozzle plate 14 has a bifurcated channel 14f branching in two directions in the X direction from the channel opening-closing portion 14d. The sealing member 8a at the tip of the needle valve 8 tightly contacts the channel opening-closing portion 14d. Channels of the bifurcated channel 14f communicate with the corresponding nozzles 14a. If the flow velocities of the liquid droplets discharged from the respective nozzles 14a are approximately the same and the landing timings are synchronized well, the dimensions of the channels of the bifurcated channel 14f and the diameters and depths of the multiple nozzles 14a may be made different from each other. Further, if the landing timings are synchronized well, the liquid may be discharged from three or more nozzles by one liquid discharge module.

In this modification, liquid droplets can be discharged from multiple nozzles 14a by one liquid discharge module 1. Accordingly, the number of liquid discharge modules 1 can be reduced, and the cost of the apparatus can be reduced.

In this modification, the nozzle pitch in the nozzle array can be reduced as compared with the configuration in which one nozzle 14a is disposed on the axis of the needle valve 8. Such a configuration can obtain, with one nozzle array, a resolution in the X direction that is substantially the same as that obtained when two nozzle arrays are arranged in a staggered manner.

The liquid discharge head according to the present embodiment adopts the valve jet system, and can discharge liquid having high viscosity or large droplets (diameter of several tens to several hundred m) toward a discharge target at a distance (several tens mm ahead). Further, the nozzle diameter can be increased, and for example, a liquid containing a material with a large particle diameter can be favorably discharged. Since liquid having high viscosity can be discharged as described above, the liquid discharge head according to the present embodiment is suitable for coating, for example, a vehicle body of a car or a truck, a fuselage of an airplane, a wall surface of a building, or a road surface, or printing an image. The liquid discharge head according to the present embodiment is also suitable for forming, for example, an electrode of a lithium ion battery mounted on a vehicle body.

An example of a liquid discharge apparatus including the liquid discharge head 10 described above will be described below.

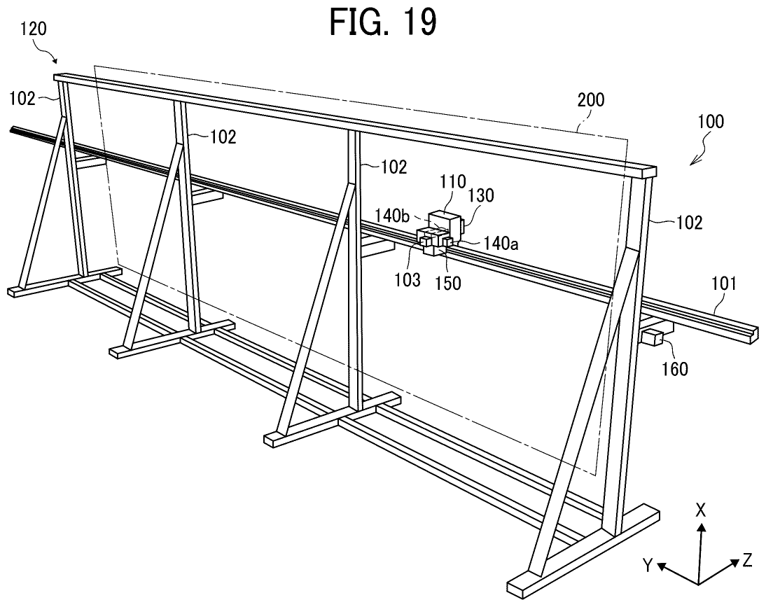

FIG. 19 is a schematic perspective view of a liquid discharge apparatus 100.

The liquid discharge apparatus 100 includes a movable frame unit 120 which is installable to face a discharge target 200 (i.e., a medium). The frame unit 120 includes a Y-axis rail 101 extending in the horizontal direction, multiple X-axis rails 102 extending in the vertical direction at predetermined intervals in the horizontal direction, and a Z-axis rail 103 intersecting the X-axis rails 102 and the Y-axis rail 101.

The X-axis rails 102 hold the Y-axis rail 101 such that the Y-axis rail 101 extending horizontally can move in the X direction (i.e., the nozzle array direction of the liquid discharge head 10, and the vertical direction). The Y-axis rail 101 movably holds the Z-axis rail 103 in the Y direction. The Z-axis rail 103 movably holds a carriage 110 in the Z direction.

The carriage 110 includes a head holder 130. The head holder 130 holds, for example, liquid discharge heads for different colors. For example, the head holder 130 holds a liquid discharge head for discharging cyan paint, a liquid discharge head for discharging magenta paint, a liquid discharge head for discharging yellow paint, and a liquid discharge head for discharging black paint. These paints are an example of the liquid. The head holder 130 may further hold a liquid discharge head for discharging white paint. The head holder 130 may further hold a liquid discharge head for discharging a clear (transparent) coating material to perform coating simultaneously with printing.

The frame unit 120 further includes a first Z-direction driver 140a that moves the carriage 110 in the Z direction (i.e., the liquid discharge direction, and the direction of approaching and separating from the discharge target 200) along the Z-axis rail 103. The frame unit 120 further includes a Y-direction driver 150 that moves the Z-axis rail 103 in the Y direction (i.e., the direction orthogonal to both the liquid discharge direction and the nozzle array direction of the liquid discharge head 10, and the horizontal direction) along the Y-axis rail 101. The frame unit 120 further includes an X-direction driver 160 that moves the Y-axis rail 101 in the X direction (the nozzle array direction of the liquid discharge head 10, and the vertical direction) along the X-axis rail 102. The Y-axis rail 101 is supported by X-direction driver 160 held by the X-axis rails 102. The frame unit 120 further includes a second Z-direction driver 140b that moves the head holder 130 relative to the carriage 110 in the Z direction.

The liquid discharge apparatus 100 discharges paint from the liquid discharge head 10 mounted on the head holder 130 while moving the carriage 110 along the X-axis, the Y-axis, and the Z-axis to draw images on the discharge target 200. The paint is an example of liquid. The movement of the carriage 110 and the head holder 130 in the Z direction may not be parallel to the Z direction, and may be an oblique movement including at least a Z direction component. When the liquid discharge head has one nozzle array, the liquid discharge head may be held by the carriage 110 so as to be inclined with respect to the X direction of the liquid discharge head to change the nozzle pitch. With such a configuration, the carriage 110 is moved to move the liquid discharge head 10 mounted on the carriage 110.

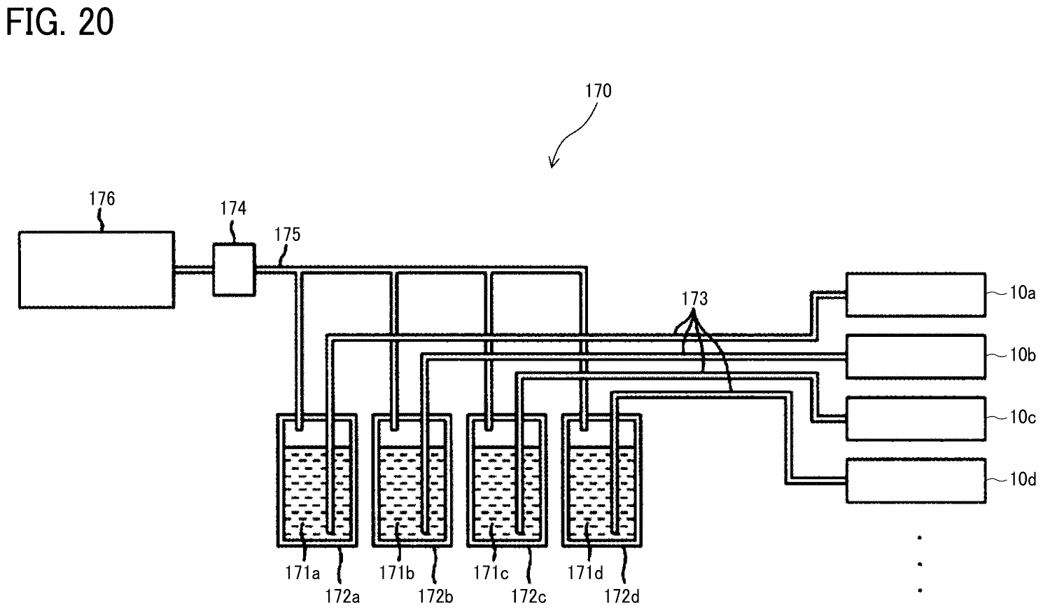

FIG. 20 is a diagram illustrating a supply device 170 that supplies paint as a liquid to multiple liquid discharge heads 10 (e.g., liquid discharge heads 10a, 10b, 10c, and 10d) included in the liquid discharge apparatus 100.

The supply device 170 includes tanks 172a to 172d as closed containers that accommodate paints 171a to 171d (i.e., a liquid) to be discharged from the liquid discharge heads 10a to 10d held by the head holder 130. These components may be collectively referred to without suffixes.

The tanks 172 and the supply ports 12 of the liquid discharge heads 10 (see FIG. 1) are respectively connected to each other via tubes 173. The tanks 172 are coupled to a compressor 176 via a pipe 175 including an air regulator 174. The compressor 176 supplies pressurized air to the tanks 172. Thus, the paint 171 in the liquid discharge head 10 is pressurized, and the paint 171 is discharged from the nozzle 14a opened by the needle valve 8.

Although the discharge target 200 is flat in FIG. 19, the discharge target 200 may have a surface shape which is nearly vertical or a curved surface with a large radius of curvature, such as the body of a car, a truck, or an aircraft.

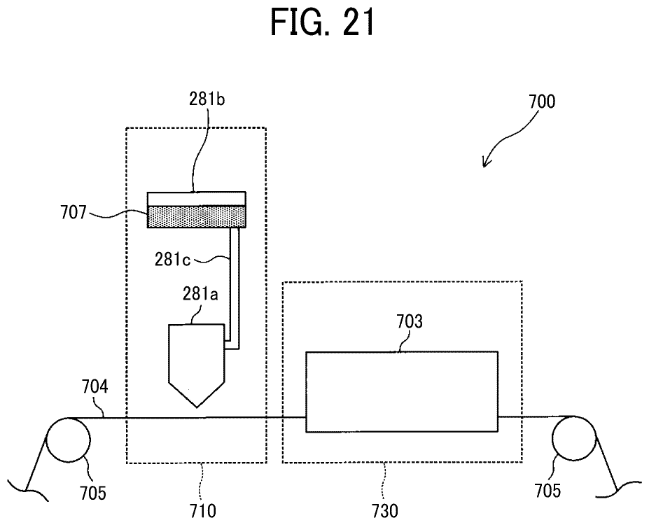

FIG. 21 is a diagram illustrating an electrode manufacturing apparatus 700 as a liquid discharge apparatus including the liquid discharge head 10.

The electrode manufacturing apparatus 700 includes a discharge process unit 710 and a heating process unit 730. The discharge process unit 710 performs the discharge process in which a liquid composition (i.e., a liquid) is applied to a print base material 704 (i.e., a medium) having the discharge target to form the liquid composition layer. The heating process unit 730 performs a heating process in which the liquid composition layer is heated to obtain the electrode composite layer.

The print base material 704 is not limited to any particular object and can be suitably selected to suit any application. The print base material 704 is any object on which a layer containing an electrode material can be formed, such as an electrode substrate (current collector), an active material layer, and a layer containing a solid electrode material.

The discharge process unit 710 may directly discharge the liquid composition to form the layer having the electrode material on the print base material 704. Alternatively, the discharge process unit 710 may indirectly discharge the liquid composition to form the layer having the electrode material on the print base material 704.

The heating process unit 730 heats the liquid composition discharged onto the print base material 704 by the discharge process unit 710. The liquid composition layer can be dried by heating.

The electrode manufacturing apparatus 700 further includes a conveyance unit 705 that conveys the print base material 704. The conveyance unit 705 conveys the print base material 704, at a preset speed, to the discharge process unit 710 and the heating process unit 730 in this order. A method of producing the print base material 704 having the discharge target such as an active material layer is not limited to any particular method, and a known method can be appropriately selected. The discharge process unit 710 includes a printer 281a including the liquid discharge head 10 that discharges the liquid composition onto the print base material 704. The discharge process unit 710 further includes a storage container 281b, and a supply tube 281c. The storage container 281b stores a liquid composition 707 (i.e., a liquid). The supply tube 281c supplies the liquid composition 707 stored in the storage container 281b to the printer 281a.

The storage container 281b stores the liquid composition 707, and the discharge process unit 710 discharges the liquid composition 707 from the printer 281a to apply the liquid composition 707 onto the print base material 704 to form the liquid composition layer in a thin film shape. The storage container 281b may be integrated with the electrode manufacturing apparatus that forms the electrode composite layer or may be detachable from the electrode manufacturing apparatus. The storage container 281b may include a container for adding the liquid composition 707 to the storage container integrated with the electrode manufacturing apparatus or the storage container detachable from the electrode manufacturing apparatus.

The storage container 281b that stably stores the liquid composition 707 and the supply tube 281c that stably supplies the liquid composition 707 can be used.

The heating process unit 730 includes a heater 703 to perform a solvent removing process in which the solvent remaining in the liquid composition layer is heated and dried by the heater 703 to be removed. Thus, the electrode composite layer can be formed. The heating process unit 730 may perform the solvent removing process under reduced pressure.

The heater 703 is not limited to any particular device and can be suitably selected to suit any application. Examples of the heater 703 include a substrate heater, an infrared (IR) heater, a hot-air heater, and the combination thereof. The heating temperature and time can be appropriately selected according to the boiling point of the solvent contained in the liquid composition 707 and the thickness of the formed film.

When the electrode manufacturing apparatus 700 including the liquid discharge head 10 is used, the liquid composition can be discharged to a desired position of the discharge target. The electrode composite layer can be suitably used, for example, as a part of the configuration of an electrochemical element. The configuration of the electrochemical element other than the electrode composite layer is not limited to any particular configuration and may be appropriately selected from known configurations. Examples thereof include a positive electrode, a negative electrode, and a separator.

The above-described embodiments are illustrative and do not limit the present disclosure. Numerous additional modifications and variations are possible in light of the above teachings. It is therefore to be understood that within the scope of the appended claims.

In the above description, the embodiments in which the drive control device 30 applies a voltage to the driver such as the piezoelectric element 2a to move the needle valve 8 to open and close the nozzle 14a have been described. However, the present disclosure is not limited thereto, and the needle valve 8 may be moved to open and close the nozzle 14a by pneumatic pressure or hydraulic pressure. In such a case, the drive pulse generated by the drive control device 30 is a drive waveform for driving a pneumatic or hydraulic pressurizing mechanism with a preset pressure.

In the above-described embodiments, the “liquid discharge apparatus” includes the liquid discharge head or the liquid discharge unit in which the liquid discharge head is integrated with a functional part(s) or mechanism(s) and drives the liquid discharge head to discharge liquid. The above integration may be achieved by, for example, a combination in which the liquid discharge head and a functional part(s) or mechanism(s) are fixed to each other through, e.g., fastening, bonding, or engaging, and a combination in which one of the liquid discharge head and a functional part(s) or mechanism(s) is movably held by another. The liquid discharge head may be detachably attached to the functional part(s) or mechanism(s) each other.

The liquid discharge head and the head tank may be assembled, or the liquid discharge head and the head tank may be coupled (connected) to each other via, for example, a tube to form the liquid discharge unit as a single unit. A unit including a filter may further be added to a portion between the head tank and the liquid discharge head of the liquid discharge unit.

The liquid discharge unit may be an integrated unit in which the liquid discharge head and the carriage are integrated as a single unit, or the liquid discharge head, the carriage, and a scanning moving mechanism are integrated as a single unit. As yet another example, the liquid discharge unit is a unit in which the liquid discharge head and the scanning moving mechanism are combined into a single unit. The liquid discharge head is movably held by a guide that is a part of the scanning moving mechanism.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit. Further, in another example, the liquid discharge unit includes a tube connected to the liquid discharge head mounting the head tank or the channel component so that the liquid discharge head and the supply device are integrated as a single unit. Through the tube, the liquid in a liquid storage source is supplied to the liquid discharge head.

The scanning moving mechanism may be a guide only. The supply mechanism may be a tube(s) only or a loading unit only.

The “liquid discharge apparatus” may be, for example, any apparatus that can discharge liquid to a medium onto which liquid can adhere or any apparatus to discharge liquid toward gas or into a different liquid.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” is a discharge target or an object onto which liquid is discharged as described above and represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, and ceramic.

The liquid discharge apparatus may be an apparatus to relatively move a head unit (e.g., a unit including the liquid discharge head) and the medium onto which liquid can adhere. However, the liquid discharge apparatus is not limited to such an apparatus. For example, the liquid discharge apparatus may be a serial head apparatus that moves the head unit or a line head apparatus that does not move the head unit.

Examples of the “liquid discharge apparatus” further include a treatment liquid coating apparatus to discharge a treatment liquid to a sheet to coat a surface of the sheet with the treatment liquid to reform the sheet surface.

Examples of the “liquid discharge apparatus” further include an injection granulation apparatus in which a composition liquid including raw materials dispersed in a solution is injected through nozzles to granulate fine particles of the raw materials.

The embodiments described above are just examples, and the various aspects of the present disclosure attain respective effects as follows.

### Aspect 1

A liquid discharge head 10 includes a nozzle 14a to discharge a liquid, a valve such as a needle valve 8 to open and close the nozzle 14a, and a moving mechanism 6 to move the valve between an open position at which the nozzle 14a is opened and a closed position at which the nozzle 14a is closed. The moving mechanism 6 includes an actuator 2 and an arm 3 having a connection portion 3d connected to the actuator 2 and a contact portion 3a contacting the valve. The arm 3 is swingably supported. An arm side face (in the above-described embodiment, an inner circumferential face of the through hole 3b) of the arm 3 faces an outer circumferential face of the valve extending in a movement direction (Z direction) of the valve with a predetermined clearance.

In other words, a liquid discharge head includes a nozzle plate, a valve, an actuator, and an arm. The nozzle plate has a nozzle to discharge a liquid. The valve extends in a first direction and is movable in the first direction to open and close the nozzle. The valve includes a contacted portion in a part of the valve. The actuator is displaceable to move the valve relative to the nozzle. The arm is swingable by a displacement of the actuator to move the valve in the first direction between an open position at which the valve opens the nozzle and a closed position at which the valve closes the nozzle. The arm extends in a second direction intersecting the first direction. The arm has a connection portion, a contact portion, and an arm side face. The connection portion is connected to the actuator. The connection portion is disposed at one end of the arm in the second direction. The contact portion contacts the contacted portion of the valve in the first direction. The contact portion is disposed at another end of the arm opposite the one end in the second direction. The arm side face faces an outer circumferential face of the valve with a clearance.

In the above-described comparative example, the push rod is movably supported by the housing in the movement direction of the valve element. The push rod is fixed to the lever which is swung by the displacement of the actuator. Accordingly, the push rod is swung together with the lever. As a result, for example, the push rod may contact the housing and may not smoothly move in the displacement direction of the valve element. As a result, the valve element as a valve, which is moved by the displacement of the push rod, may not be moved smoothly and may not be displaced stably.

By contrast, in Aspect 1, the predetermined clearance is formed between the outer circumferential face of the valve and the arm side face facing the outer circumferential face of the valve extending in the movement direction of the valve. The arm is swung by the displacement of the actuator. Thus, when the arm is swung by the displacement of the actuator, the arm side face of the arm can be prevented from colliding with the outer circumferential face of the valve. Such a configuration can prevent the arm side face of the arm from contacting the outer circumferential face of the valve and thus does not hinder the valve from moving. As a result, the valve can be moved smoothly, the valve can be displaced stably, and liquid droplets can be discharged stably from the nozzle.

### Aspect 2

In Aspect 1, the liquid discharge head 10 further includes a restrictor such as a valve bearing 20 to restrict the movement of the valve such as the needle valves 8 in the direction orthogonal to the movement direction (Z direction). A clearance d1 between the arm side face (inner circumferential face of the through hole 3b) and the outer circumferential face is wider than a clearance d2 between a restricting side face of the restrictor facing the outer circumferential face and the outer circumferential face.

In other words, the liquid discharge head according to Aspect 1, further includes a restrictor to restrict a movement of the valve in an orthogonal direction orthogonal to the first direction. The restrictor has a restricting side face facing the outer circumferential face of the valve with another clearance. The clearance between the arm side face of the arm and the outer circumferential face of the valve is wider than said another clearance between the restricting side face and the outer circumferential face of the valve.

Due to such a configuration, as described in the above embodiment, the arm side face can be prevented from colliding with the valve when the arm is swung as compared with a configuration in which the clearance d1 between the arm side face (inner circumferential face of the through hole 3b) and the outer circumferential face is equal to or less than the clearance d2 between the restricting side face of the restrictor such as the valve bearing 20 and the outer circumferential face. The restricting side face of the restrictor faces the outer circumferential face of the valve.

### Aspect 3

In Aspect 1 or 2, the liquid discharge head 10 further includes a biasing member such as a compression spring 7 pressing a contacted portion such as an arm receiving portion 8c of the needle valve 8 against the contact portion 3a of the arm 3. The contact portion 3a contacts the contacted portion in the movement direction (Z direction). The contact portion 3a contacts the central portion of the contacted portion when viewed in a swing axis direction (X direction) of the arm 3. The contact portion 3a remains in contact with the central portion of the contacted portion when the arm 3 is swung.

In other words, the liquid discharge head according to Aspect 1, further includes a biasing member pressing the contacted portion of the valve against the contact portion of the arm in the first direction and a swing axis extending in a third direction orthogonal to the first direction and the second direction. The arm is swung about the swing axis. The contact portion of the arm is kept in contact with a central portion of the contacted portion of the valve during a swing of the arm.

Due to such a configuration, as described in the above embodiment, when the arm 3 is swung, the contacted portion such as the arm receiving portion 8c can be prevented from being tilted following the tilt of the arm 3 by the biasing force of the biasing member. Such a configuration can prevent the needle valve 8 together with the contacted portion from being tilted. Accordingly, the needle valve 8 can be prevented from colliding with the arm side face such as the inner circumferential face of the through hole 3b or colliding with the restrictor such as the valve bearing 20. Thus, the valve can be displaced stably.

### Aspect 4

In Aspect 3, a contact surface of the contact portion 3a of the arm 3 with the contacted portion such as the arm receiving portion 8c has an arc shape when viewed in the swing axis direction (X direction) of the arm 3.

In other words, the contact portion of the arm has an arced shaped contact surface in a cross section orthogonal to the third direction.

Due to such a configuration, as described in the above embodiment, when the arm 3 is swung, the contact of the contact portion 3a with the central portion of the contacted portion can be maintained.

Further, when the arm 3 is swung, the contact position of the contact surface of the contact portion with the contacted portion can be smoothly shifted, and the arm 3 can be smoothly swung.

### Aspect 5

In any one of Aspects 1 to 4, the arm side face is a side face of a pass-through portion such as a through hole 3b formed in the arm 3. The valve such as the needle valve 8 is inserted through the through hole 3b.

In other words, the contact portion of the arm has a pass-through portion through which the valve is inserted, and the pass-through portion has the arm side face.

Due to such a configuration, as described in the above embodiment, when the arm 3 is swung, the side face of the pass-through portion can be prevented from colliding with the valve such as the needle valve 8, and thus the needle valve 8 is not hindered from moving.

### Aspect 6

In Aspect 5, the pass-through portion has a hole shape or a groove shape. A part of the outer circumferential face of the valve such as the needle valve 8 is exposed from the groove shape.

In other words, the pass-through portion has a through hole, or the pass-through portion has a groove into which a part of the outer circumferential face of the valve is fitted.

Due to such a configuration, as described in the above embodiment, when the arm 3 is swung, the inner circumferential face of the pass-through portion having the hole shape or the side face of the pass-through portion having the groove shape can be prevented from colliding with the valve such as the needle valve 8, and thus the needle valve 8 is not hindered from moving.

### Aspect 7

In any one of Aspects 1 to 6, when viewed in the swing axis direction of the arm 3 (X direction), a line A2 connecting a connected position S of the connection portion 3d with the body 3f of the arm 3 and the center O1 of the swing of the arm 3 is orthogonal to the displacement directions A1 of the actuator 2 in the OFF state of the actuator 2.

In other words, the liquid discharge head according to any one of claims 1 to 6, further includes a swing axis extending in a third direction orthogonal to the first direction and the second direction. The arm includes a body that swings about the swing axis. A line connecting a connected position of the connection portion with the body of the arm and the swing axis is orthogonal to displacement directions of the actuator in an off state of the actuator.

Due to such a configuration, as described in the above embodiment, the direction to press the connected position S when a voltage is applied to the actuator and the actuator is displaced can be matched with the direction to displace the connected position S when the arm is swung. Thus, the arm can be swung favorably by the displacement of the actuator.

### Aspect 8

In any one of Aspects 1 to 7, a bottom face 3fa of the body 3f of the arm 3 is flat.

In other words, the arm has a flat bottom surface.

Due to such a configuration, as described in the above embodiment, the arm 3 can be stably placed on the reference surface of the reference member such as the block gauge, and the arm member can be prevented from being tilted in the direction of swing with respect to the posture (initial posture) when the actuator is in the OFF state during the assembling of the liquid discharge module. As a result, the clearance d1 between the arm side face and the needle valve can be accurately set to a predetermined clearance, and the arm side face can be favorably prevented from colliding with the needle valve when the arm is swung. Further, the line A2 connecting the connected position S of the connection portion 3d with the body 3f of the arm 3 and the center O1 of the swing of the arm 3 can be accurately made orthogonal to the displacement directions A1 of the actuator 2 in the OFF state of the actuator 2.

### Aspect 9

In any one of Aspects 1 to 8, the arm 3 amplifies the displacement of the actuator 2 to move the valve such as the needle valve 8.

Due to such a configuration, as described in the above embodiment, the amount of movement of the valve is increased, and the gap between the nozzle and the valve when the valve is at the open position can be increased. As a result, liquid easily flows to the nozzle, the amount of the liquid discharged from the nozzle is increased, and the size of liquid droplets can be increased.

### Aspect 10

In any one of Aspects 1 to 9, the liquid discharge head 10 further includes multiple nozzles 14a, multiple needle valves 8, and multiple moving mechanisms 6.

In other words, the liquid discharge head according to any one of claims 1 to 9, further includes multiple actuators including the actuator, multiple arms including the arm, and multiple valves including the valve. The multiple arms respectively correspond to the multiple actuators. The multiple valves respectively correspond to the multiple arms. The nozzle plate further has multiple nozzles including the nozzle to be opened and closed by the multiple valves, respectively.

Due to such a configuration, liquid droplets can be discharged from the multiple nozzles, and thus productivity can be enhanced.

### Aspect 11

In any one of Aspects 1 to 10, the valve such as the needle valve 8 opens and closes the multiple nozzle 14a.

In other words, the nozzle plate further has multiple nozzles including the nozzle, and the valve opens and closes the multiple nozzles.

Due to such a configuration, as described in the above modification, the number of valves or moving mechanisms can be reduced, and the cost of the apparatus can be reduced.

### Aspect 12

In a liquid discharge apparatus 100 including the liquid discharge head 10, the liquid discharge head according to any one of Aspects 1 to 11 is used as the liquid discharge head 10.

In other words, a liquid discharge apparatus includes the liquid discharge head according to any one of Aspects 1 to 11, to discharge a liquid onto a medium and a carriage mounting the liquid discharge head to move the liquid discharge head relative to the medium.

Due to such a configuration, a high-quality image can be obtained.

As described above, according to one aspect of the present disclosure, the valve can be displaced stably.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having a nozzle to discharge a liquid;
a valve:
extending in a first direction;
movable in the first direction to open and close the nozzle; and
including a contacted portion in a part of the valve;
an actuator displaceable to move the valve relative to the nozzle; and
an arm swingable by a displacement of the actuator to move the valve in the first direction between:
an open position at which the valve opens the nozzle; and
a closed position at which the valve closes the nozzle,
wherein the arm extends in a second direction intersecting the first direction, and the arm has:
a connection portion connected to the actuator, the connection portion disposed at one end of the arm in the second direction;
a contact portion contacting the contacted portion of the valve in the first direction, the contact portion disposed at another end of the arm opposite the one end in the second direction; and
an arm side face facing an outer circumferential face of the valve with a clearance.

2. The liquid discharge head according to claim 1, further comprising a restrictor to restrict a movement of the valve in an orthogonal direction orthogonal to the first direction, the restrictor having a restricting side face facing the outer circumferential face of the valve with another clearance,
wherein the clearance between the arm side face of the arm and the outer circumferential face of the valve is wider than said another clearance between the restricting side face and the outer circumferential face of the valve.

3. The liquid discharge head according to claim 1, further comprising:
a biasing member pressing the contacted portion of the valve against the contact portion of the arm in the first direction; and
a swing axis extending in a third direction orthogonal to the first direction and the 35 second direction,
wherein the arm is swung about the swing axis, and
the contact portion of the arm is kept in contact with a central portion of the contacted portion of the valve during a swing of the arm.

4. The liquid discharge head according to claim 3,
wherein the contact portion of the arm has an arced shaped contact surface in a cross section orthogonal to the third direction.

5. The liquid discharge head according to claim 1,
wherein the contact portion of the arm has a pass-through portion through which the valve is inserted, and
the pass-through portion has the arm side face.

6. The liquid discharge head according to claim 5,
wherein the pass-through portion has a through hole.

7. The liquid discharge head according to claim 5,
wherein the pass-through portion has a groove into which a part of the outer circumferential face of the valve is fitted.

8. The liquid discharge head according to claim 1, further comprising a swing axis extending in a third direction orthogonal to the first direction and the second direction,
wherein the arm includes a body that swings about the swing axis, and
a line connecting a connected position of the connection portion with the body of the arm and the swing axis is orthogonal to displacement directions of the actuator in an off state of the actuator.

9. The liquid discharge head according to claim 1,
wherein the arm has a flat bottom surface.

10. The liquid discharge head according to claim 1,
wherein the arm amplifies the displacement of the actuator to move the valve.

11. The liquid discharge head according to claim 1, further comprising:
multiple actuators including the actuator;
multiple arms including the arm, the multiple arms respectively corresponding to the multiple actuators; and
multiple valves including the valve, the multiple valves respectively corresponding to the multiple arms,
wherein the nozzle plate further has multiple nozzles including the nozzle to be opened and closed by the multiple valves, respectively.

12. The liquid discharge head according to claim 1,
wherein the nozzle plate further has multiple nozzles including the nozzle, and
the valve opens and closes the multiple nozzles.

13. A liquid discharge apparatus comprising:
the liquid discharge head according to claim 1, to discharge a liquid onto a medium; and
a carriage mounting the liquid discharge head to move the liquid discharge head relative to the medium.
